(19) United States
(12) Patent Application Publication
(10) Pub. No.: US 2005/0102104 A1
(43) Pub. Date: May 12, 2005

(54) Providing custom locations and custom color scales for online weather radar displays

(75) Inventor: Robert L. Parsons, Crossville, TN (US)

Correspondence Address: PITTS AND BRITTIAN P C, P O BOX 51295, KNOXVILLE, TN, 37950-1295, US

(73) Assignee: TAP Publishing Company, Crossville, TN (US)

(21) Appl. No.: 10/705,333

(22) Filed: Nov. 10, 2003

(51) Int. Cl. G06F 19/00

(52) U.S. Cl. 702/3

(57) ABSTRACT

Apparatus and methods for customizing the display of weather radar at a client. A weather information system allows a user at a client to add custom locations to the radar display and to customize the color scale used to represent the quantities measured or derived by the radar. A server stores the user information and acquires weather information, which is sent to the client upon request. The client executes software that communicates with the server and renders the information on the client's display unit in accordance with the preselected custom features.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to the presentation of meteorological data on a computer monitor and more particularly the ability to depict user-specified geographic locations and user-specified color scales on weather data delivered via the Internet or other suitable transport mechanism.

2. Description of the Related Art

Many weather data providers provide access to the United States National NEXRAD radar network. This network consists of approximately 150 individual radar sites operated by the National Oceanographic and Atmospheric Administration, the Federal Aviation Administration, and the United States Air Force. Data obtained from the NEXRAD network is disseminated for use by commercial, military, and private users throughout the United States.

The development and commercialization of the World Wide Web in 1993 offered an ideal mechanism for dissemination of the NEXRAD data stream. Many commercial providers began offering access to the NEXRAD data through the internet by using a common web browser data is normally distributed to end users as a bitmapped image that depicts the magnitude of measured quantities via a color code. Since radar data is spatially significant, a map depicting political boundaries and other geographic features is often depicted over the image. This arrangement allows the viewer to determine the magnitude and position of measured and derived quantities from the radar.

Although color scales often vary by provider, it is traditionally fixed and static to allow easy transmission and display of the data using common web browsers. The map that is superimposed on the radar data also varies by provider but is typically fixed and allows no user customization.

### BRIEF SUMMARY OF THE INVENTION

Apparatus and methods for customizing the display of weather radar is disclosed. A weather information system provides a mechanism allowing a user to add custom locations to the radar display and to customize the color scale used to represent the quantities measured or derived by the radar. Custom locations are entered at a client and stored in a database. Custom color scales are similarly entered at the client. After the user makes a request for a radar image, the server retrieves the custom location and color scale information and codes it into an HTML document, which is sent to the client. The client renders the HTML which in turn executes a special applet which loads the radar data from the server, applies the custom color scales and locations, and displays the data on the client display.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the invention;

FIG. 2 is a flow chart of one embodiment of the customization process;

FIG. 3 is a flow chart of one embodiment of the retrieval and display process; and

FIG. 4 is a flow chart of one embodiment of the rendering process.

### DETAILED DESCRIPTION OF THE INVENTION

An apparatus and method for customizing and displaying weather information is disclosed. Recognizing the value in allowing the viewer to control the color scale as well as adding their own features to the overlay map, the current invention seeks to overcome the limitations imposed by browser technology by applying a combination of techniques to allow for greater customization while still enabling the use of standard browser software.

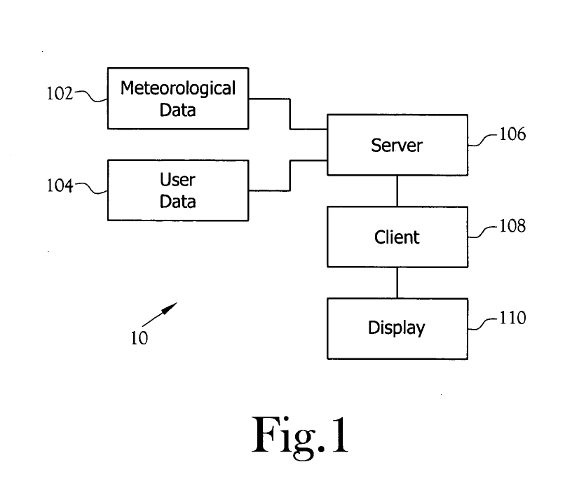

FIG. 1 illustrates the weather information system 10. The meteorological data 102 and the user data 104 are accessed by a server 106, which communicates with one or more clients 108 to provide weather information on a display unit 110. In one embodiment, the display unit 110 is a computer monitor and the client is a computer with keyboard and mouse. The server 106 communicates over a network to the clients 106. In one embodiment, the network is the Internet.

The meteorological data 102 includes, in one embodiment, raw weather radar images. In other embodiments, the meteorological data 102 includes weather radar images and images of geographical regions showing various weather information. In various embodiments, the raw weather radar images are derived from data transmitted via the Internet, leased line, satellite, or other media.

The user data 104 includes, in one embodiment, user identification information and custom information. In various embodiments, the user data 104 includes user preferences, custom color information, and custom location information. User preferences include, but are not limited to, initial information to display and sets of images to display.

The meteorological data 102 and the user data 104, in one embodiment, are stored in a data storage device, which includes a database of tables containing the meteorological data 102 and the user data 104. The data storage device is in communication with the server 106, and the data storage device can be any of various devices known in the art for storing data, such as, but not limited to, a hard disk, a network attached storage device (NAS), recordable optical disks, and a stand-alone networked data storage device. Although FIG. 1 illustrates the meteorological data 102 and the user data 104 communicating directly with the server 112, in another embodiment, the meteorological data 102 and the user data 104 are stored in another computing device that is connected to the network and communicates with the server 106.

Further, as used herein, a “client” should be broadly construed to mean any computer or component thereof directly or indirectly connected or connectable in any known or later-developed manner to a computer network, such as the Internet or a local area network. Examples of a client include, but are not limited to, a personal computer, a terminal that communicates over the Internet, and an Internet connected television. The client 108 runs, or executes, software that communicates with the server 106.

The term “server” should also be broadly construed to mean a computer, computer platform, an adjunct to a computer or platform, or any component thereof that provides data or information to a client. The server 106 runs, or executes, software that allows it to properly handle and process client requests, in addition to other processes necessary for the server 106 to perform its required functions. Of course, a client should be broadly construed to mean the equipment that requests or gets a file or information, and a server is the equipment that provides the file or information. These terms are based on the function of the associated equipment and the terms may interchange as the function of a particular piece of equipment changes.

The server 106 and the client 108 should be broadly construed to mean any computer or component thereof that executes software. In one embodiment the server 106 and the client 108 are general purpose computers, in another embodiment, one or the other or both are a specialized device for implementing the functions of the invention. Those skilled in the art will recognize that the server 106 and the client 108 each include an input component, an output component, a storage component, and a processing component. The input component receives input from external devices. For example, the server 106 receives input from one or more clients 108, with the input, in one embodiment, including requests for data. The output component sends output to external devices. For example, the server 106 sends output to one or more clients 108, with the output, in one embodiment, including HTML pages. The storage component stores data and program code, such as the meteorological data 102 and the user data 104. In one embodiment, the input component and the output component form a single input/output component that includes the functions of both the input and the output components. In one embodiment, the storage component includes random access memory. In another embodiment, the storage component includes non-volatile memory, such as floppy disks, hard disks, and writeable optical disks. The processing component executes the instructions included in the software and routines.

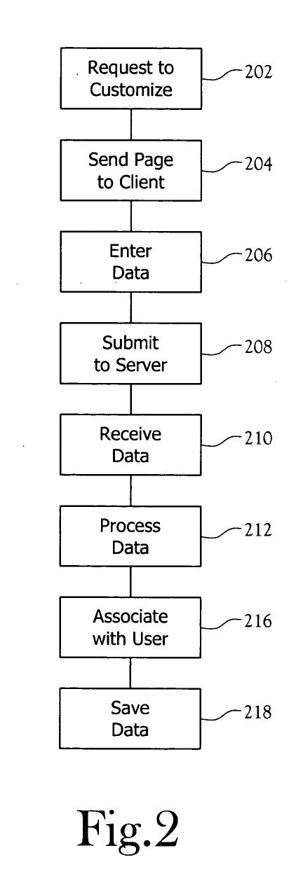

In one embodiment, each of the functions identified in FIGS. 2 to 4 are performed by one or more software routines run by either the server 106 or the client 108. In another embodiment, one or more of the functions identified are performed by hardware and the remainder of the functions are performed by one or more software routines run by the either the server 106 or the client 108.

The server 106 and the client 108 execute software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routines or perform more than one function.

For an HTML (hypertext markup language) based system, the client 108 runs or executes software that communicates with the server 106. The client software is typically known as browser software, and in one embodiment, is a standard web browser such as Netscape or Microsoft Internet Explorer. In other embodiments, custom software performs the functions of the browser software. The browser software executes on the client 108 and performs the functions of communicating with the server 106, displaying data and information provided by the server 106, sending user input from the client 108 to the server 106, and processing applets or sub-routines. Browser applets or sub-routines are programs executed on the client 108 that are controlled by the browser software to perform special functions not normally available in the browser software.

FIG. 2 illustrates a flow diagram of one embodiment of user customization. A user operates the client 108 and places a request to customize 202. The client 108 sends the request to the server 106. The server 106 produces an HTML page containing interface elements that allow the user to enter custom data. The server 106 responds by sending the HTML page 204 to the client 108. The HTML page is transmitted through the Internet to the client 108 where the browser software renders it onscreen and allows input to be taken. The user enters data 206 at the client in data entry fields on the HTML page. After the user completes data entry 206, the user submits the data 208 to the server 106. The server 106 receives the data 210 and processes the data 212 by executing software running on the server 106.

To enable the display of custom locations, the user must first specify the geographic location of the point they wish to mark, along with information describing how to display the marker and optionally an accompanying label. If the received data 210 includes a location specified by street address, then a geocoding process is invoked to resolve the street address to a latitude and longitude. The latitude and longitude, along with the rest of the submitted data, is associated with an identification code that uniquely identifies the user 216. The data is saved 218 and persists until the user changes or deletes it. After the data has been processed and saved 218, control is passed back to the user at the client 108 who is free to continue browsing the site. If the received data 210 includes custom color information, then a process is invoked to represent the custom colors in a format usable by the server 106 to generate the HTML pages 308.

With the above user customization method, the user, in one embodiment, enters data on the HTML page specifying one or more custom locations that are plotted on weather information images. In various embodiments, the user specifies the geographic locations by latitude and longitude, by street address, or by other distinguishing names or identifiers. In another embodiment, the user specifies custom color scales, which includes the exact colors the user desires to use, along with information detailing which scale should be applied to which radar data set. In various embodiments, the HTML page form is designed such that the user may specify color values by selecting them from a color box, by entering the red, green, and blue component values, or by choosing from a number of pre-set values. Other embodiments allow the user to associate different radar data sets to different custom color scales.

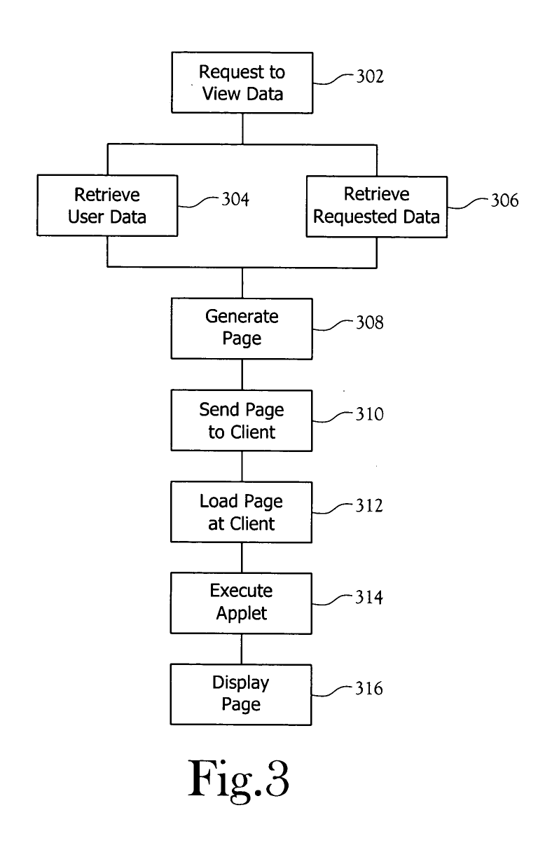

FIG. 3 illustrates a flow diagram for viewing data at the client 108. The user at the client 108 sends a request to view data 302 to the server 106. The server 106 executes software to retrieve user data 304 for the specific user requesting the data and to retrieve the requested data 306. After the server 106 retrieves the data 304, 306, the server 106 generates an HTML page 308 containing the requested data, customized as the user requested previously. The server 106 sends the generated page 310 to the client 108. The step of generating the page 308, includes, in one embodiment, inserting a special set of HTML tags in the HTML page that instructs the software running on the client 108 to download and execute the radar data display applet. In various embodiments, the custom location and color scale data previously selected by the user is placed within the special applet tag.

At the client 108, the generated page 310 is loaded 312 by software running on the client 108. In one embodiment, the client 108 executes a radar data display applet 314. The applet 314, in conjunction with the browser software running on the client 108, displays, or renders, the page 316, showing the custom locations and using the custom colors, as appropriate.

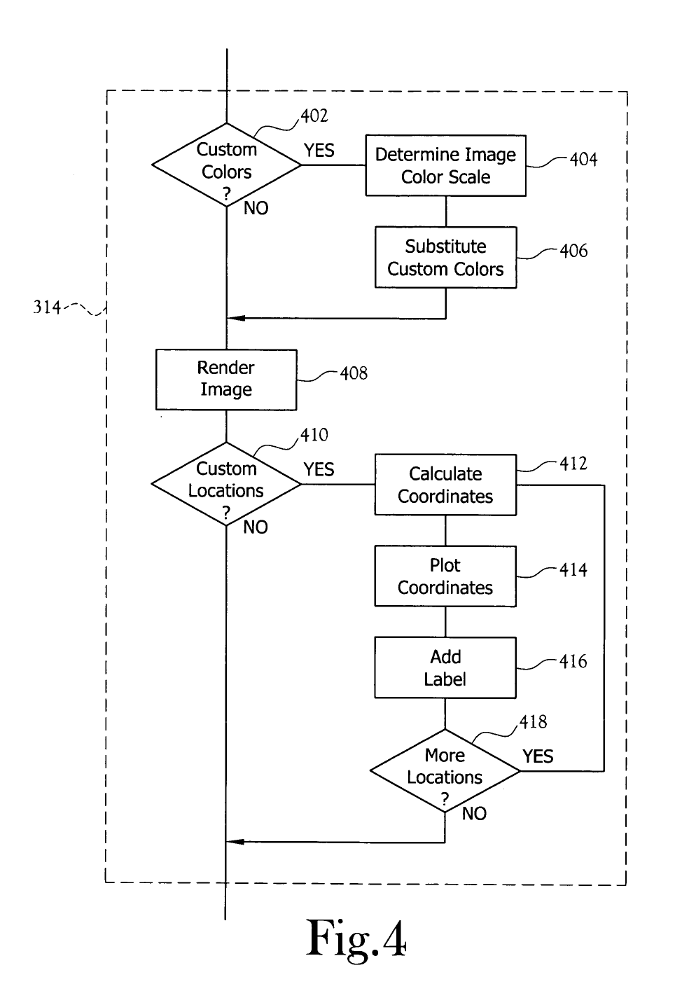

FIG. 4 illustrates a flow diagram for rendering/displaying the weather information as performed by one embodiment of the applet 314. In one embodiment, as part of displaying the page 316, the display applet 314 calls a routine to implement any custom color scales. The routine determines whether a custom scale has been defined 402 and is appropriate for the current radar data set by analyzing the data passed into the applet. If a custom color scale is applicable, then the native color scale of the image is determined 404. This may be done by having pre-existing knowledge of the color scale being used. Alternatively, an unknown color scale may be determined by sampling parts of the image known to contain the color of a particular quantity. For example, if the native radar image has a color scale reproduced on the image, it may be possible to determine the color definitions by sampling a pixel extracted from each block in the color scale.

With the native scale known, and the new custom scale known, the image is processed by substituting the native scale color with the corresponding custom scale color 406. This may be accomplished by polling and modifying every pixel within the radar image, or in certain cases (such as 8-bit non-transparent images) by simply modifying the image palette values. After color substitution, the radar image will reflect the new color scale. The new image is substituted for the native image pulled from the server and rendered 408 on the client 108.

If the user wishes to display their custom locations on the radar map, they simply indicate their intentions 410 through a checkbox or other suitable user interface mechanism. For each custom location, the rendering routine calculates the x, y coordinates 412 within the currently displayed radar image that represents the latitude and longitude of the custom location. This calculation is made by using a conversion algorithm appropriate to the map projection and location being utilized. The calculated x, y coordinates are plotted 414 and a marker symbol is positioned at the appropriate place on the image and a label is added 416. Both the marker symbol and the label attributes may be customized by the user. If more locations 418 have been identified, the routine repeats until all custom locations have been rendered.

Although the invention is described as including HTML pages, the invention is not so limited. The illustrated embodiment shows HTML pages being sent from the server 106 to the client 108, which is executing browser software. In another embodiment, the server 106 sends a data set to the client 108. The data set includes the information necessary for the software running on the client 108 to display the customized weather information. In one embodiment, the client is executing a software program that acts upon the data set, which includes both the weather images and the data necessary to customize its display. In this embodiment, the software program on the client 108, although performing the same functions as the general purpose browser software, is not a general purpose browser.

The system for customizing and displaying weather information includes various functions. The function of acquiring and storing meteorological data is implemented by the server 106 retrieving the requested data 306 and storing the data in the storage component. The function of acquiring and storing user data is implemented by the server 106 receiving the custom user data from the client 108 and storing the data in the storage component. The function of acquiring and storing user data includes the server 106 and the client 108 executing a process as illustrated in FIG. 2 for customizing user data. The function of generating customized data sets from said meteorological data and said user data is implemented by the server 106 generating the data set 308.

The server for storing and generating customized weather information includes various functions. The function of acquiring and storing meteorological data is implemented by the server 106 retrieving the requested data 306 and storing the data in the storage component. The function of acquiring and storing user data is implemented by the server 106 receiving the custom user data from the client 108 and storing the data in the storage component function of generating customized data sets from said meteorological data and said user data is implemented by the server 106 generating the data set 308. The function of sending said customized data sets to a client is implemented by the server 106 communicating with the client 108 to send the data set 310.

The client for customizing and displaying weather information includes various functions. The function of entering user data is implemented by the client 108 executing a process for requesting to customize 202, for entering data 206, and submitting the data 208 to the server 106. The function of requesting meteorological data is implemented by the client 108 executing a process for requesting to view data 302. The function of rendering customized data sets from said meteorological data and said user data is implemented by the client 108 executing a process for loading a data set 312 and executing an applet 314. The function of displaying said customized data sets is implemented by the client 108 executing a process for executing an applet 314 and displaying the image 316.

From the foregoing description, it will be recognized by those skilled in the art that apparatus and methods for customizing and displaying weather information has been provided. The weather information system includes a server that collects and stores weather data and user data, and the server also communicates with at least one client. The client is operated by a user, who enters custom information and requests weather information, which is displayed on a display unit attached to the client.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A computer system for customizing and displaying weather information, comprising:
a server programmed to execute a process including:
acquiring raw weather data;
receiving and storing custom user data;
retrieving said stored custom user data;
generating a data set from said raw weather data and said custom user data, said data set containing a weather image;
inserting a set of tags in said data set that instruct a client to download and execute a radar data display applet;
embedding information in said data set relating to said custom user data; and
sending said data set to said client; and
a client programmed to execute a process including:
sending custom user data to a server;
requesting a specific weather information image;
receiving a plurality of data sets from said server;
executing an applet for applying said custom user data to a weather image; and
rendering said weather image on a display unit.

2. The process of claim 1 wherein said custom user data includes at least one custom color, said at least one custom color applied to an attribute on said data set.

3. The process of claim 1 wherein said custom user data includes at least one custom color, said at least one custom color applied to an attribute on said weather image.

4. The process of claim 1 wherein said custom user data includes at least one custom location, said at least one custom location converted to a coordinate system suitable for plotting with said data set.

5. The process of claim 1 wherein said custom user data includes at least one custom location, said at least one custom location plotted on said weather image.

6. The process of claim 1 wherein said custom user data includes at least one custom color and at least one custom location, said at least one custom color applied to an attribute on said weather image, said at least one custom location plotted on said weather image.

7. The process of claim 1 wherein said data set is an HTML page.

8. At least one computer programmed to execute a process for customizing and displaying weather information, the process comprising:
acquiring raw weather data;
receiving and storing custom user data, said custom user data including at least one custom location;
retrieving said stored custom user data;
generating a data set from said raw weather data and said custom user data, said data set for producing a weather image;
inserting a set of tags in said data set that instruct a client to download and execute a radar data display applet;
embedding information in said data set relating to said custom user data; and
sending said data set to said client.

9. The process of claim 8 wherein said custom user data includes at least one custom color, said at least one custom color applied to an attribute on said data set.

10. The process of claim 8 wherein said at least one custom location is converted to a coordinate system suitable for plotting with said data set.

11. The process of claim 8 wherein said data set is an HTML page.

12. At least one computer programmed to execute a process for customizing and displaying weather information, the process comprising sending custom user data to a server;
requesting a specific weather information image from said server;
receiving a data set from said server;
executing an applet for applying said custom user data to said data set for displaying a weather image; and
rendering said weather image on a display unit.

13. The process of claim 12 wherein said custom user data includes at least one custom color, said at least one custom color applied to an attribute on said weather image.

14. The process of claim 12 wherein said custom user data includes at least one custom location, said at least one custom location plotted on said weather image.

15. The process of claim 12 wherein said custom user data includes at least one custom color and at least one custom location, said at least one custom color applied to an attribute on said weather image, said at least one custom location plotted on said weather image.

16. Computer readable media tangibly embodying a program of instructions executable by a server to perform a method of storing and transmitting customized weather information, said method comprising:
acquiring raw weather data;
receiving and storing custom user data;
retrieving said stored custom user data;
generating a data set from said raw weather data and said custom user data, said data set for displaying a weather image;
inserting a set of tags in said data set that instruct a client to download and execute a radar data display applet;
embedding information in said data set relating to said custom user data; and
sending said data set to a client.

17. The process of claim 16 wherein said custom user data includes at least one custom color, said at least one custom color applied to an attribute on said weather image.

18. The process of claim 16 wherein said custom user data includes at least one custom location, said at least one custom location plotted on said weather image.

19. The process of claim 16 wherein said custom user data includes at least one custom location, said at least one custom location is converted to a coordinate system suitable for plotting on said weather image.

20. The process of claim 16 wherein said data set is an HTML page.

21. Computer readable media tangibly embodying a program of instructions executable by a client to perform a method of customizing and displaying weather information, said method comprising:
sending custom user data to a server;
requesting a specific weather information image from said server;
receiving a plurality of data sets from said server;
executing an applet for applying said custom user data to said data set for displaying a weather image; and
rendering said weather image on a display unit.

22. The process of claim 21 wherein said custom user data includes at least one custom color, said at least one custom color applied to an attribute on said weather image.

23. The process of claim 21 wherein said custom user data includes at least one custom location, said at least one custom location plotted on said weather image.

24. The process of claim 21 wherein said custom user data includes at least one custom color and at least one custom location, said at least one custom color applied to an attribute on said weather image, said at least one custom location plotted on said weather image.

25. A method in a client computer system for communicating weather information to a user, comprising:
providing for a prompt to the user for entering custom data relating to a weather image;
providing for storing said custom data; and
providing for presenting said weather image to the user, said weather image including said custom data.

26. The method of claim 25 wherein said custom data includes at least one custom location, said at least one custom location plotted on said weather image.

27. The method of claim 25 wherein said custom data includes at least one custom color, said at least one custom color applied to an attribute on said weather image.

28. A server for storing and transmitting customized weather information, said server comprising:
a storage component for storing user data and meteorological data;
an input/output component for communicating with a client; and
a processing component executing a process including acquiring raw weather data, storing and retrieving said raw weather data, acquiring custom user data, storing and retrieving said custom user data, generating an data set from said raw weather data and said custom user data, and sending said data set to said client.

29. The server of claim 28 wherein said custom data includes at least one custom location, said at least one custom location identifying a point on said weather image.

30. The server of claim 28 wherein said custom data includes at least one custom color, said at least one custom color to be applied to an attribute on said weather image.

31. A client for customizing and displaying weather information, said client comprising:
a storage component for user data and meteorological data;
an input/output component for communicating with a server; and
a processing component executing a process including sending custom user data to a server, receiving a plurality of data sets from said server, executing an applet for applying said custom user data to a weather image, and rendering said weather image on a display unit.

32. The client of claim 31 wherein said custom data includes at least one custom location, said at least one custom location plotted on said weather image.

33. The client of claim 31 wherein said custom data includes at least one custom color, said at least one custom color applied to an attribute on said weather image.

34. An computer system for customizing and displaying weather information, said computer system comprising:
a means for acquiring and storing meteorological data;
a means for acquiring and storing user data;
a means for generating customized data sets from said meteorological data and said user data; and
a means for displaying said customized data sets.

35. A server for storing and generating customized weather information, said server comprising:
a means for acquiring and storing meteorological data;
a means for acquiring and storing user data;
a means for generating customized data sets from said meteorological data and said user data; and
a means for sending said customized data sets to a client.

36. A client for customizing and displaying weather information, said client comprising:
a means for entering user data;
a means for requesting meteorological data;
a means for rendering customized data sets from said meteorological data and said user data; and
a means for displaying said customized data sets.
